(19) United States
(12) Patent Application Publication
(10) Pub. No.: US 2025/0054129 A1
(43) Pub. Date: Feb. 13, 2025

(54) VIAL INSPECTION APPARATUS AND METHOD BASED ON HYPERSPECTRAL IMAGE AND AI MODEL

(71) Applicant: SK bioscience Co., LTD, Seongnam-si (KR)

(72) Inventors: Geon Hyeong LEE, Seongnam-si (KR); Sung Joo YEO, Seongnam-si (KR); Daekeun KWON, Seongnam-si (KR); Hyuck Soo LIM, Seongnam-si (KR)

(73) Assignee: SK bioscience Co., LTD, Seongnam-si (KR)

(21) Appl. No.: 18/800,657

(22) Filed: Aug. 12, 2024

(30) Foreign Application Priority Data
Aug. 10, 2023 (KR) 10-2023-0104685
Aug. 12, 2024 (KR) 10-2024-0107920

(51) Int. Cl. G06T 7/00

(52) U.S. Cl. CPC G06T 7/0004; G06T 2207/20081; G06T 2207/20084; G06T 2207/30108

(57) ABSTRACT

A product inspection method based on a hyperspectral image and an artificial intelligence model, includes: receiving the hyperspectral image acquired by photographing a product to be inspected with a hyperspectral camera; detecting an abnormal area in the hyperspectral image using a first machine learning model; and discriminating a type of abnormality found in the detecting the abnormal area in the hyperspectral image using a second machine learning model.

### CROSS-REFERENCE TO RELATED APPLICATIONS

This application claims priority to Korean Patent Application Nos. 10-2023-0104685 (filed on Aug. 10, 2023) and 10-2024-0107920 (filed on Aug. 12, 2024), which are all hereby incorporated by reference in their entirety.

### BACKGROUND

The present disclosure relates to a quality control (QC) method for a product production process, and more specifically, to an inspection apparatus and method for determining whether a product produced in a product production process is normal or abnormal based on a hyperspectral image and an artificial intelligence model.

In general, products produced in a product production process such as pharmaceuticals and beverages call for a quality control (QC) process immediately after production. For example, drugs including various blood products produced in a pharmaceutical process are medicines that are directly injected into the blood of a human body, so it is required to determine whether the drugs are defective in the QC process after product production. Generally, these drugs are produced in small glass bottles called vials, and in the conventional QC process, workers manually determine whether each vial is normal. In other words, conventionally, workers visually inspected the vial to be inspected for approximately 1 to 2 seconds, determined whether there were foreign substances in the vial, and decided normal/defective based thereon.

However, in this conventional method, since many vials are visually inspected and determined directly by workers, the normal/defective decision may be wrong. Furthermore, there is a large deviation depending on the worker, and additional costs are incurred due to cross-verification to prevent this deviation. In addition, the Ministry of Food and Drug Safety recently recommended increasing the vial inspection time from 1 second to 5 seconds or more for manual vial inspection, which raises concerns about increased inspection time and additional cost increases in the future.

In addition, there is a method of deciding abnormalities/defects using a camera. However, since this method checks for foreign substances in a single wavelength rather than various wavelengths, there were frequent cases where non-foreign substances were determined as foreign substances or foreign substances were determined as non-foreign substances, which resulted in low inspection accuracy. Even when foreign substances were determined to be found, it was difficult to specify specifically what the foreign substances were.

### SUMMARY

An aspect of the present disclosure is directed to providing an inspection method and apparatus capable of quickly and accurately deciding whether a product is normal or defective by replacing a product inspection that has been conventionally performed manually with hyperspectral imaging and artificial intelligence-based inspection.

According to an embodiment of the present disclosure, disclosed is a product inspection method based on a hyperspectral image and an artificial intelligence model, wherein the method uses a data processing unit and the artificial intelligence model executed on a computer device, and includes: a stage of receiving the hyperspectral image acquired by photographing a product to be inspected with a hyperspectral camera; a first inspection stage of detecting an abnormal area in the hyperspectral image using a first machine learning model; and a second inspection stage of discriminating a type of abnormality found in the first inspection stage using a second machine learning model.

According to an embodiment of the present disclosure, disclosed is a computer-readable recording medium having recorded thereon a computer program for executing the product inspection method.

According to an embodiment of the present disclosure, by using a hyperspectral image and a machine learning model, rather than merely determining whether an arbitrary detection area is normal or abnormal, the normality/abnormality of a detection area is determined in a first inspection, and the area determined to be abnormal is subject to a second inspection to decide the type of abnormality, thereby enabling a more accurate and rapid discrimination of normal/defective products.

### BRIEF DESCRIPTION OF THE DRAWINGS

FIG. 1 is a flowchart illustrating a vial inspection method according to an embodiment of the present disclosure.

FIG. 2 is a diagram illustrating an exemplary vial photographed image.

FIG. 3 is a diagram illustrating an exemplary detection area.

FIG. 4 is a diagram illustrating an autoencoder.

FIG. 5 is a flowchart illustrating a first inspection stage according to an embodiment.

FIG. 6 is a flowchart illustrating a second inspection stage according to an embodiment.

FIG. 7 is a diagram illustrating an exemplary hyperspectral spectrum of a normal area.

FIG. 8 is a diagram illustrating an exemplary hyperspectral spectrum of an abnormal area.

FIG. 9 is a diagram illustrating an albumin sample photographed with a hyperspectral camera.

FIG. 10 is a diagram illustrating a value calculated based on the spectral similarity of albumin data in the form of a heatmap.

FIG. 11 is a diagram illustrating a vial inspection method according to an alternative embodiment.

### DETAILED DESCRIPTION

The foregoing purposes, other purposes, features and advantages of the present disclosure will be readily understood through the following preferred embodiments related to the attached drawings. However, the spirit of the present disclosure is not limited to the exemplary embodiments described herein, but may also be implemented in other forms. Rather, the embodiments introduced herein are provided so as to make the disclosed contents be thorough and complete and to fully transfer the spirit of the present disclosure to those skilled in the art.

In the present specification, although terms “first,” “second,” and the like are used for describing various constituents, these constituents are not limited by these terms. These terms are merely used for distinguishing one constituent from the other constituents. Each exemplary embodiment described and exemplified herein also includes a complementary exemplary embodiment thereof.

In the present specification, the terms in singular form may include plural forms unless otherwise specified. The expressions “comprise,” “configured of” and “consist of” used herein indicate the existence of one or more other constituents other than stated constituents but do not exclude presence of additional constituents.

In the present specification, the term “software” refers to technology for moving hardware in a computer, the term “hardware” refers to a tangible device or apparatus (a central processing unit (CPU), a memory, an input device, an output device, a peripheral device, etc.) constituting a computer, the term “stage” refers to a series of processes or manipulations connected in time series to achieve a predetermined goal, the terms “computer program,” “program” and “algorithm” refer to a set of commands suitable for processing by a computer, and the term “program recording medium” refers to a computer-readable recording medium having a program installed therein, and having a program recorded thereon to be executed or distributed.

In the present specification, the terms “part,” “module,” “unit,” “block,” and “board” used herein to refer to the constituents of the present disclosure may mean a physical, functional, or logical unit that processes at least one function or operation, and which may be implemented by one or more hardware, software, or firmware, or a combination of hardware, software, and/or firmware.

In the present specification, a “processing unit,” a “computer,” a “computing device,” a “server device,” and a “server” may be implemented as a system having an operating system such as Windows, Mac, or Linux, a computer processor, memory, an application program, and a storage device (for example, an HDD, an SSD). The computer may be, for example, a desktop computer, a laptop, a mobile terminal, etc., but these are exemplary and not limited thereto. The mobile terminal may be one of a smart phone, a tablet PC, or a mobile wireless communication device such as a PDA.

Hereinafter, the present disclosure will be described in detail with reference to the drawings. In the following description of particular embodiments, many details are provided so as to describe the embodiments in further detail and to aid in understanding the present disclosure. However, those of ordinary skill in the art will appreciate that the embodiments could be used without such details. In addition, in describing the present disclosure, descriptions that are well known but have no direct relationship to the present disclosure will be omitted to prevent the present disclosure from being obscured.

In addition, the following detailed description described with reference to the drawings describes a vial product containing a blood preparation as an example, but those skilled in the art will understand that an inspection apparatus and method according to an embedment of the present disclosure are not limited thereto and may be applied to various products.

For example, the inspection apparatus and method according to an embodiment of the present disclosure are not applicable only to a vial containing a blood preparation, but may also be applied to products containing liquids such as various beverages, gases or solids, or gels in containers made of transparent or translucent materials such as glass or transparent plastic. In this connection, the container may be a transparent or translucent container that transmits visible light, but is not limited thereto, and any container that may transmit electromagnetic waves of a predetermined frequency band irradiated to obtain a hyperspectral image may be sufficient.

In addition, the term “foreign substance” discriminated by the inspection apparatus according to an embodiment of the present disclosure is defined in various ways depending on the specific implementation situation of an embodiment of the present disclosure. For example, the term “foreign substance” mentioned herein may be a protein lump, dust, or an insect depending on a specific embodiment of the present disclosure, and is defined as any substance or particle that should not be included in the product being produced or is preferably not included.

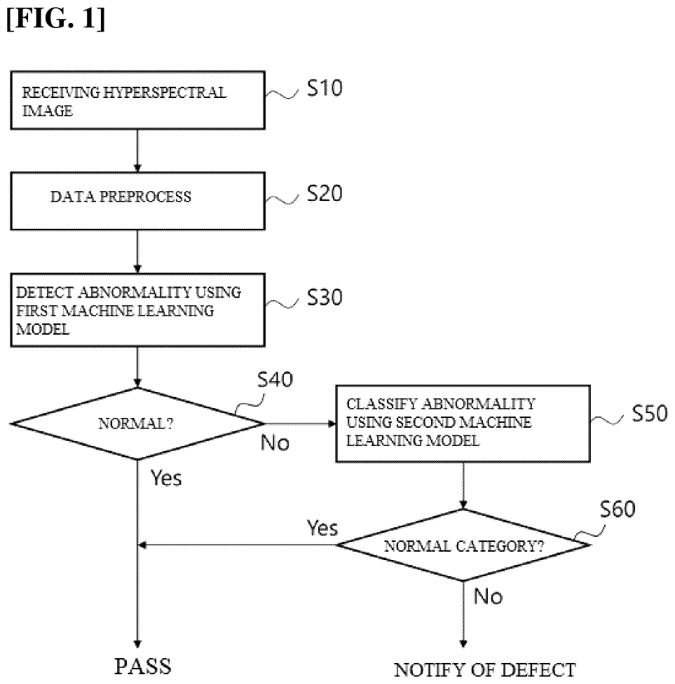

FIG. 1 is a flowchart illustrating a vial inspection method according to an embodiment of the present disclosure. The flowchart of FIG. 1 may be performed by a data processing unit and an artificial intelligence model running on a computer device. In an embodiment, the vial inspection method may include: a stage of receiving a hyperspectral image of a vial captured by a hyperspectral camera (S10); a stage of preprocessing the received hyperspectral image (S20); a first inspection stage of detecting an abnormal area in the hyperspectral image using a first machine learning model (S30); and a second inspection stage of discriminating a type of abnormality found in the first inspection stage using a second machine learning model (S50).

In this connection, when it is determined that there is no abnormality as a result of abnormality detection of the hyperspectral image for the vial in the first inspection stage (S30), it is determined to be a normal vial and released. When one or more abnormal areas are found in the first inspection stage (S30), the second inspection stage (S50) is performed for each of the abnormal areas to determine the type of abnormality. When the result of the second inspection for the abnormality is determined to be, for example, a simple protein fragment or a scratch on the surface of the vial, it is determined to be in the normal category and released normally, and when it is determined to be a foreign substance in the vial, it is finally determined to be a defective vial.

This vial inspection method according to an embodiment of the present disclosure is performed by a data processing unit and an artificial intelligence model running on a computer device. For example, the computer device may include a data preprocessing unit performing data preprocessing (S20) and an artificial intelligence model performing inspection stages (S30, S50) by the first and second machine learning models, and each of these constituents may be implemented as software programmed to be executable on the computer device (or combined with firmware, hardware, etc., as necessary).

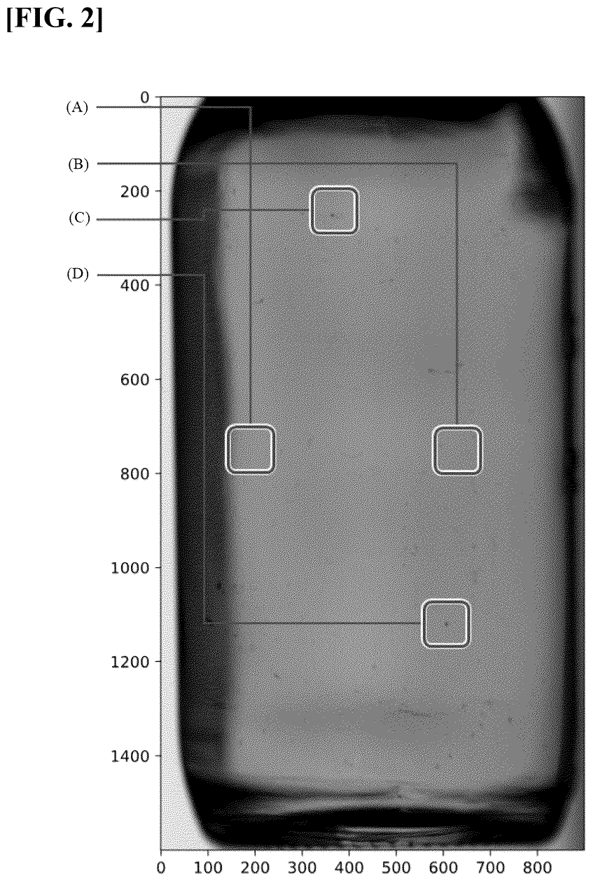

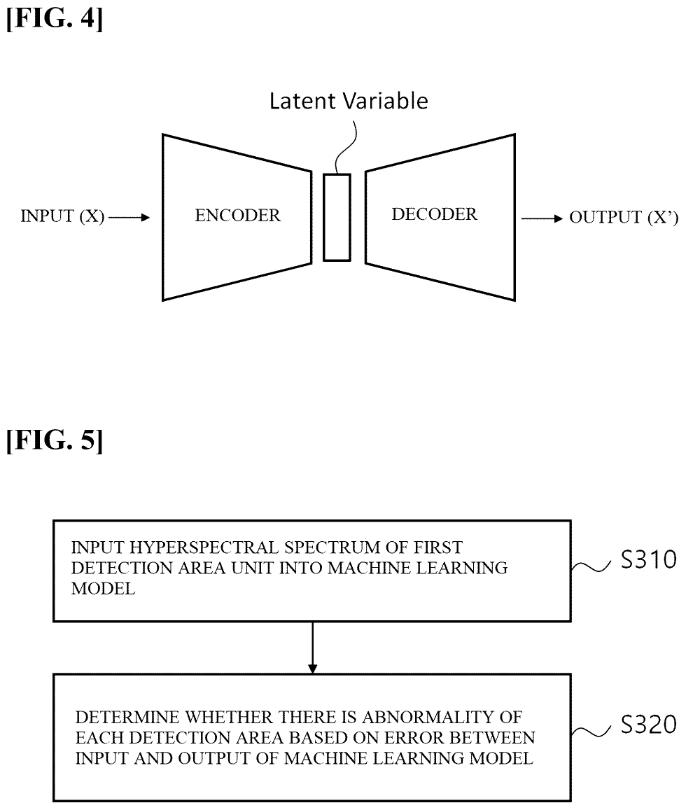

Hereinafter, the specific stages of the vial inspection method of FIG. 1 will be described with reference to FIGS. 2 to 9 as follows.

First, in stage S10 of FIG. 1, the computer device receives a hyperspectral image of the vial to be inspected captured by a hyperspectral camera. The hyperspectral image includes three-dimensional information for each pixel by combining spatial information and spectral information for a captured image. For example, the hyperspectral image includes data (for example, data on the intensity of a reflectance spectrum) of frequency bands such as ultraviolet (UV), near infrared (NIR), and shortwave infrared (SWIR) as well as the visible light area of an inspection object.

The computer device may perform preprocessing on an image after receiving the hyperspectral image of the inspection object (S20). Preprocessing is performed to remove noise from data or to speed up computer processing in subsequent inspection stages. For example, the hyperspectral image has a large amount of data, and thus may be desirable to compress the data before applying the same to a machine learning model. To this end, principal component analysis (PCA) may be performed on the hyperspectral image in the preprocessing stage (S20) to compress the data.

The hyperspectral image contains hyperspectral spectrum information in units of preset detection areas of a predetermined size, and the subsequent first inspection stage (S30) and second inspection stage (S50) are performed to determine whether the corresponding area is abnormal or normal in units of preset detection areas.

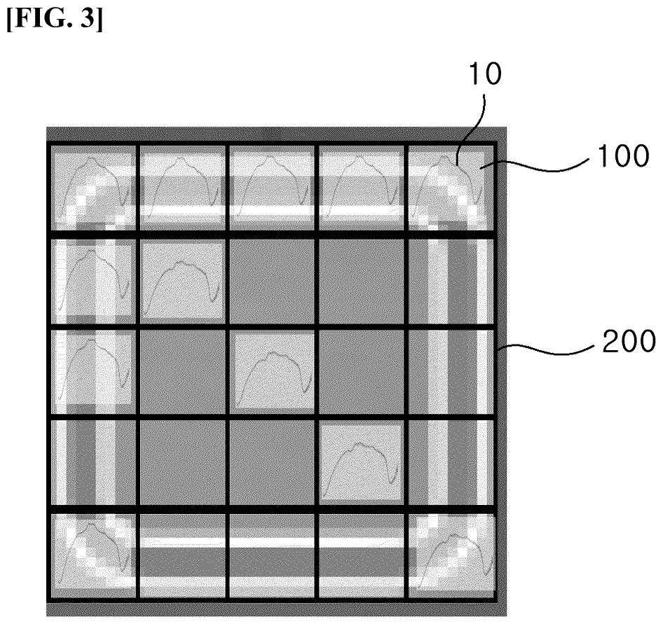

For example, FIG. 2 is a diagram illustrating an exemplary vial photographed image, and shows a visible light image as an example. In this image, for example, areas (a) and (b) are normal areas without foreign substances or scratches, and areas (c) and (d) are abnormal areas where scratches or foreign substances are visible. FIG. 3 is an enlargement of area (a) of FIG. 2, and is assumed to have a pixel size of 5×5 as an example.

In this connection, each pixel, in other words, an area with a pixel size of 1×1, may be set as a first detection area 100, and a hyperspectral spectrum 10 may be acquired for each first detection area 100. In other words, in FIG. 3, a total of 25 first detection areas 100 are shown, and some of the first detection areas are overlapped and displayed with the hyperspectral spectrum 10 of the corresponding detection areas.

Since abnormalities appearing in the vial, such as scratches of a glass, protein coagulation, and foreign substances, appear over an area much larger than one first detection area 100, a second detection area larger than the first detection area may be needed to cover one abnormality. For example, in FIG. 3, the second detection area 200 is set as an area consisting of 5×5 pixels, and in this connection, it will be understood that 25 first detection areas 100 constitute one second detection area 200.

However, it should be understood that the sizes of the aforementioned first detection areas 100 and second detection areas 200 may vary depending on the specific embodiment. For example, the first detection area 100 may be defined as 3×3 pixels or 5×5 pixels, and the second detection area 200 may be defined as 5×5 first detection areas 100 or 10×10 first detection areas 100 in each of the width×height. However, in the present specification, for convenience of explanation, it is assumed that the first detection area 100 has a size of 1×1 pixels and the second detection area 200 has a size of 5×5 pixels.

Referring to FIG. 1 again, the first inspection stage (S30) using the first machine learning model may be performed after data preprocessing. In an embodiment, the first machine learning model receives data of a hyperspectral image of the first detection area unit and decides whether the hyperspectral image is normal, and may be implemented as an autoencoder, for example.

FIG. 5 is a schematic diagram illustrating the configuration of an autoencoder. The autoencoder is a type of machine learning model that reduces the dimension of input data, compresses the same, and then restores the same to its original size. Referring to FIG. 5, the autoencoder is generally configured of an encoder and a decoder. The encoder is a model that reduces the dimension of input data, compresses the input data into a latent vector (latent variable), and outputs the same. The decoder is a model that receives a latent vector, up-samples the same back to its original size, and outputs the original data.

When an autoencoder is trained only with normal data and then abnormal data is input, the output of the autoencoder will not be completely restored to normal data, so the restoration error will inevitably increase. Accordingly, when the restoration error of certain data exceeds a predetermined threshold value, the data may be determined as abnormal.

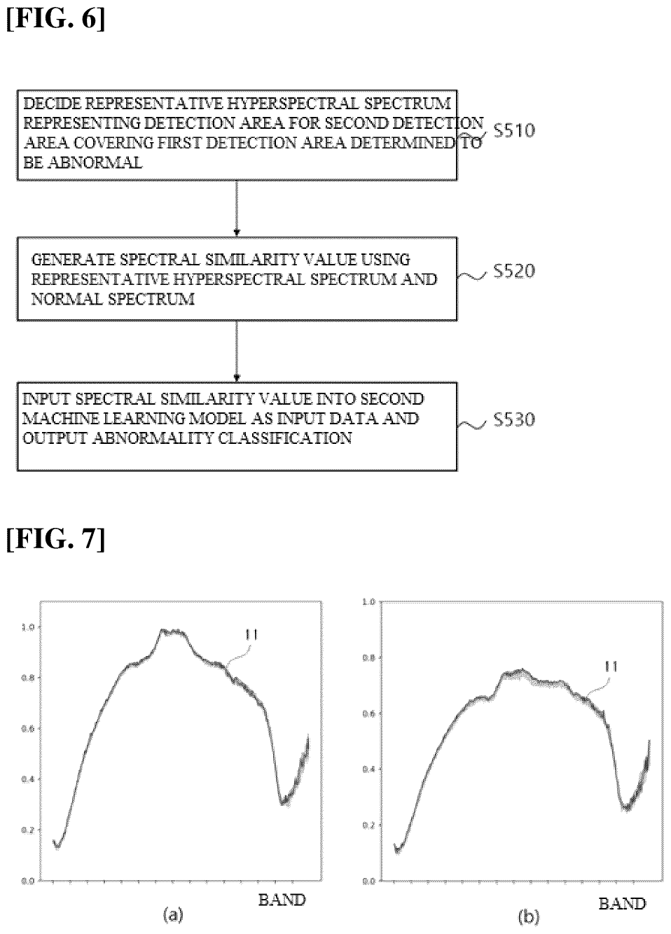

FIG. 6 is a flowchart illustrating a first inspection stage (S30) using an autoencoder. Referring to FIG. 6, in stage S310, a hyperspectral spectrum of the first detection area unit is input into the autoencoder as input data. The autoencoder outputs restored data after encoding and decoding the input data, and in stage S320, the output data of the autoencoder is compared with the input data to determine whether there is an abnormality in the hyperspectral spectrum in the first detection area unit. In other words, when the error between the input spectrum and the output spectrum is below a preset threshold value, the corresponding detection area is normal. When the error exceeds the threshold value, it may be determined that there is an abnormality in the corresponding detection area.

Referring to FIG. 1 again, the second inspection stage (S50) using the second machine learning model can be performed on the first detection area 100 discriminated to be abnormal in the inspection result of the first inspection stage (S30) using the first machine learning model. In an embodiment, the second inspection stage (S50) is a stage of discriminating the type of abnormality found in the first inspection stage using the second machine learning model.

In an embodiment, when any first detection area 100 is decided to be abnormal, a second inspection is performed on the second detection area 200 covering this area. For example, in the first inspection stage (S30), when a plurality of adjacent first detection areas 100 are decided to be abnormal due to a single scratch or foreign substance, the second detection area 200 that covers the scratch or foreign substance is selected. For example, in FIG. 2, areas (D) and (D) may be second detection areas 200 that cover the first detection areas 100 that were determined to have an abnormality as a result of the first inspection, respectively.

In the second inspection stage (S50), a machine learning model that classifies images using the spectral similarity value may be used to discriminate the type of abnormality. For example, in the second inspection stage (S50) according to an embodiment, a convolutional neural network (CNN) model is used to discriminate the type of abnormality. The CNN is a machine learning model useful for finding and classifying image recognition patterns. In general, the CNN model may classify an image by repeating a convolution layer and a pooling layer at least once at the backend of an input layer, and then passing through a fully-connected layer and a softmax function.

FIG. 6 is a flowchart illustrating an exemplary method of the second inspection stage (S50) according to an embodiment.

In stage S510, for the second detection area covering the first detection area determined to be abnormal in the first inspection stage (S30), a hyperspectral spectrum representing the corresponding detection area (hereinafter also referred to simply as a “representative hyperspectral spectrum”) is decided.

The representative hyperspectral spectrum is decided using the hyperspectral spectrum of each first detection area 100 of the corresponding second detection area 200. For example, one hyperspectral spectrum may be selected as the representative hyperspectral spectrum from among the hyperspectral spectra of all the first detection areas 100 in the second detection area 200, or a new hyperspectral spectrum may be generated using the hyperspectral spectra of all the first detection areas 100 in the second detection area 200 and set the same as the representative hyperspectral spectrum. For example, the hyperspectral spectra of all the first detection areas 100 in the second detection area 200 may be used to obtain the mode or average value in each wavelength band, and the representative hyperspectral spectrum may be selected therefrom.

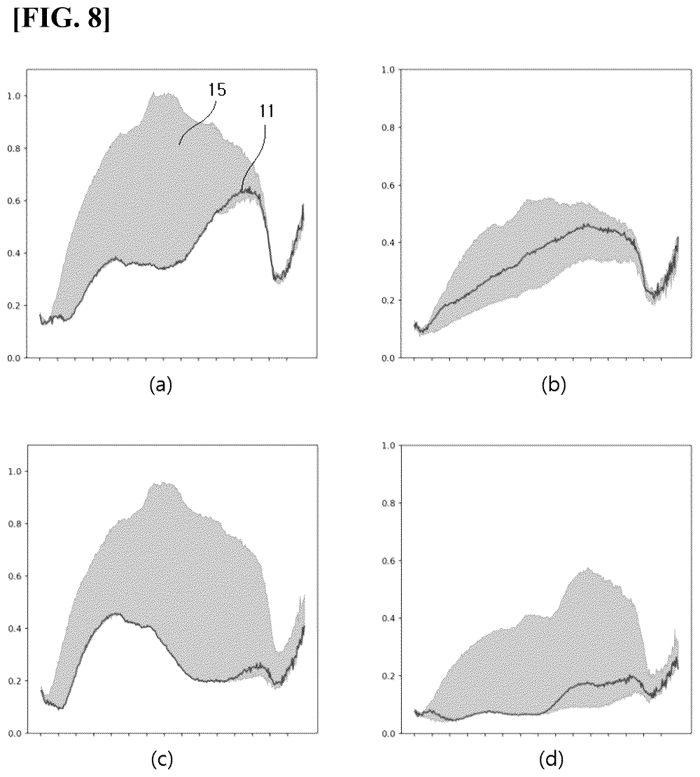

In this regard, FIGS. 7 and 8 show exemplary graphs of the hyperspectral spectrum when the second detection area 200 is normal and the hyperspectral spectrum when the second detection area 200 is abnormal.

FIGS. 7(A) and 7(B) show enlarged hyperspectral spectra of different first detection areas decided to be normal, respectively. For example, FIG. 7(A) shows, for an arbitrary second detection area 200, the hyperspectral spectra of all first detection areas 100 within the detection area by overlapping the same in one graph, and also shows a representative hyperspectral spectrum 11 selected (or newly generated) from the hyperspectral spectra of all the overlapped first detection areas 100.

For example, as in FIG. 3, when the first detection area 100 is a 1×1 pixel and the second detection area 200 is 5×5 pixels, including 25 first detection areas 100, the second detection area 200 includes 25 hyperspectral spectra. In this connection, FIG. 7(A) displays 25 hyperspectral spectra for the arbitrary second detection area 200 by overlapping the same, and the graph indicated by the red line among the same is the representative hyperspectral spectrum 11.

FIG. 8(A) and FIG. 8(B) show typical spectra of scratches on a vial glass bottle among the above. For example, when the first detection area 100 is a 1×1 pixel and the second detection area 200 is 5×5 pixels, including 25 first detection areas 100, FIG. 8(A) shows an area 15 represented by overlapping 25 hyperspectral spectra for the arbitrary second detection area 200, and the red line shows the representative hyperspectral spectrum 11 selected using the 25 hyperspectral spectra. In addition, FIG. 8(C) and FIG. 8(D) show a typical spectrum of foreign substances in a vial among the abnormalities.

As seen from FIGS. 7 and 8, the distribution and deviation (dispersion) of the hyperspectral spectrum of the normal area and the hyperspectral spectrum of the abnormal area are different, and the distribution and deviation of the hyperspectral spectrum of the second detection area 200 are different depending on the type of abnormality (for example, scratches, foreign substances, etc.).

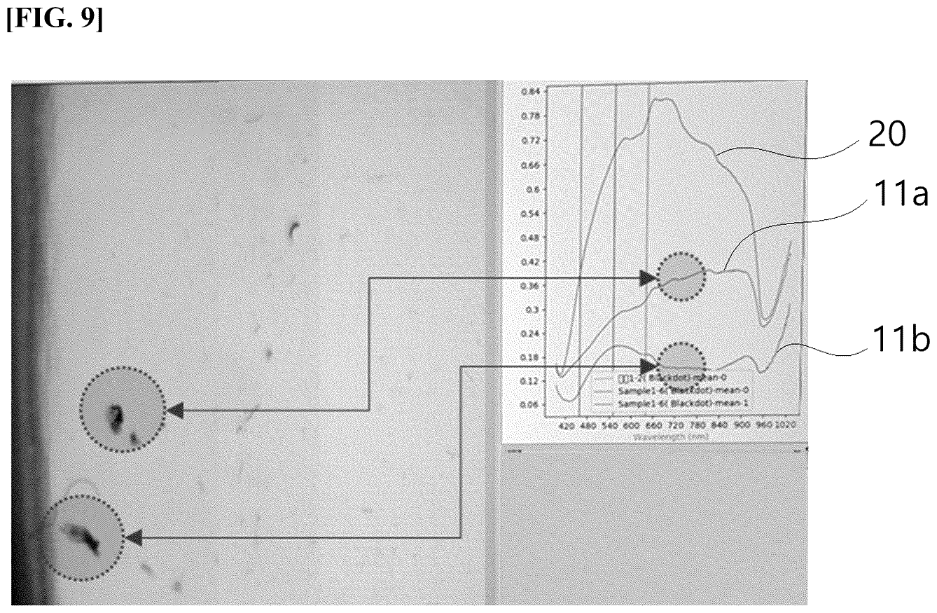

FIG. 9 is a diagram illustrating an albumin sample photographed with a hyperspectral camera as another example. In FIG. 9, the left area is an image captured by a camera, and in this image, two abnormal areas are marked with red circles, and the representative hyperspectral spectrum for each abnormal area is displayed on the right. Among the two abnormal areas, the upper area is proved to be a scratch and the lower area is proved to be a foreign substance. In this connection, it may be seen that the hyperspectral spectra 11a and 11b of each abnormal area are different from the normal hyperspectral spectrum 20, and the hyperspectral spectra 11a and 11b of the two abnormal areas also show different distributions.

Referring to FIG. 6, in stage S520, a spectral similarity value is generated using the representative hyperspectral spectrum and the normal spectrum generated in stage S510. In the second inspection stage (S50), the type of abnormality is determined using a machine learning model (hereinafter referred to as the “second machine learning model”) that classifies an image. In this connection, in an embodiment of the present disclosure, the similarity value of the image spectrum (spectral similarity value) is used as input data to be input into the second machine learning model.

The spectral similarity value may be calculated by a known method that numerically scales the similarity (for example, similarity of brightness of light, spectral shape, etc.) between the representative hyperspectral spectrum of the second detection area and a preset normal hyperspectral spectrum. In an embodiment, the second inspection stage (S50) uses a heatmap as the spectral similarity value. The spectral similarity-based heatmap according to an embodiment of the present disclosure visualizes the similarity between the representative hyperspectral spectrum of the second detection area and the preset normal spectrum with color. For example, the spectral similarity-based heatmap according to an embodiment of the present disclosure may be generated using a known method such as a correlation heatmap that visualizes the correlation between two variables.

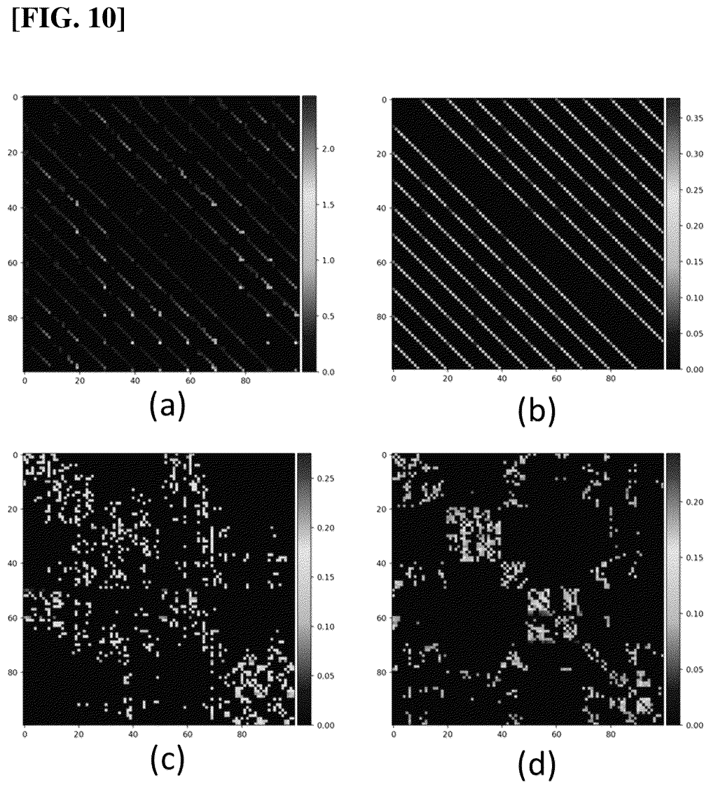

For example, FIG. 10 is a diagram illustrating a value calculated based on the spectral similarity of albumin data in the form of a heatmap, where FIG. 10(A) and FIG. 10(B) show heatmaps of normal albumin specimens, FIG. 10(C) shows a heatmap of a case where there is a scratch on the outer surface of a vial, and FIG. 10(D) shows a heatmap of a specimen containing foreign substances inside a vial, respectively.

Referring to FIG. 6 again, in stage S530, when the spectral similarity value (for example, a heatmap based on spectral similarity) for the second detection area 200 to be inspected is calculated as such, the spectral similarity value is input into the second machine learning model to determine the type of abnormality in the second detection area 200.

For example, the second machine learning model is the CNN model, the spectral similarity value (for example, a heatmap based on similarity) is input into the CNN as input data, and the CNN model outputs the result of the classification of the abnormality as output data.

As a result of this second inspection (S50), when the reason for determining the abnormality is a simple protein fragment or a scratch on the surface of a vial, it is determined to be in the normal category and released normally (S60_Yes in FIG. 1). When the reason for the abnormality is determined to be a foreign substance in the vial, it is finally determined to be a defective vial (S60_No in FIG. 1).

As such, the vial inspection method according to an embodiment of the present disclosure may discriminate whether the abnormal area has a scratch or a foreign substance by analyzing the hyperspectral spectrum of the abnormal area. Furthermore, it is possible to determine the type of foreign substance. In other words, according to an embodiment of the present disclosure, by using a hyperspectral image and a machine learning model, rather than merely determining whether an arbitrary detection area is normal or abnormal, the normality/abnormality of a detection area is determined in a first inspection, and the area determined to be abnormal is subject to a second inspection to decide the type of abnormality, thereby enabling a more accurate and rapid discrimination of normal/defective products.

One of the important indicators used to evaluate the performance of a classification model is an area under the receiver operating characteristic curve (AUROC), which is an indicator criterion indicating how well the model performs binary classification. The vial inspection method according to an embodiment of the present disclosure has been derived after collecting 48,000 pixel-unit spectrum data with a total of 31 albumin samples and conducting several tests, and an AUROC value reaches an average of 96%. This means that the accuracy of foreign substance discrimination is very high.

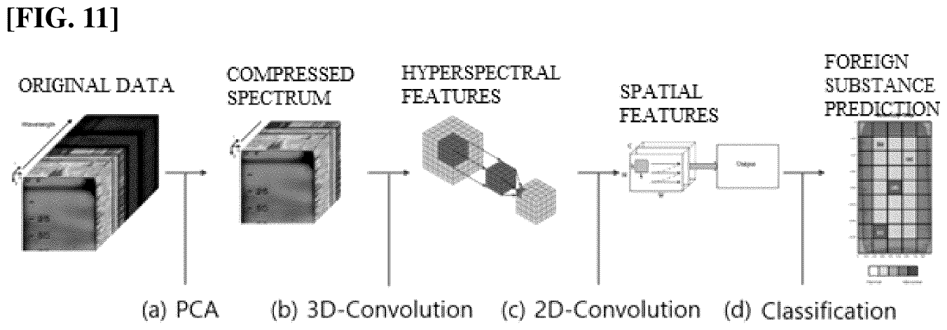

FIG. 11 is a diagram illustrating a vial inspection method according to an alternative embodiment. According to the alternative embodiment, normality and abnormality may be classified based on a model that classifies a foreign substance type at once without going through two stages of inspection (S30 and S50) as in the aforementioned embodiment. For example, a method that utilizes the probability distribution distance between a normal spectrum and a foreign substance spectrum as a measure of similarity, such as SID, or a preprocessing method such as PCA, is applied to best express the spectrum of each foreign substance type.

For example, referring to the exemplary method of FIG. 11, assuming that the first detection area 100 is a 1×1 pixel, in stage (a), the hyperspectral image data is compressed by dimensionality reduction using principal component analysis (PCA) in units of the first detection area 100. Next, in stage (b), a 3D-convolutional network technique that may train all hyperspectral features for each pixel is applied, and then in stage (c), a 2D-convolutional network is applied so that the relationship between the target pixel and the surrounding pixels, in other words, the spatial features, may be trained well based on the representative spectrum shape for each pixel and the spectrum of the surrounding pixels. Finally, by performing classification in stage (d), it is possible to probabilistically determine which type of the final representation output in the classification stage is among a plurality of predefined foreign substance detection-related types.

Hereinbefore, a person having ordinary skill in the art to which the present disclosure pertains will appreciate that various modifications and variations are possible from the description of the specification. Therefore, the scope of protection of the present disclosure should not be limited to the described embodiments, but should be defined not only by the claims described below but also by equivalents of the claims.

### DETAILED DESCRIPTION OF MAIN ELEMENTS

10 and 11: Hyperspectral spectra
100: First detection area
200: Second detection area

1. A product inspection method based on a hyperspectral image and an artificial intelligence model, the method using a data processing unit and the artificial intelligence model executed on a computer device and comprising:
a stage of receiving the hyperspectral image acquired by photographing a product to be inspected with a hyperspectral camera (S10);
a first inspection stage of detecting an abnormal area in the hyperspectral image using a first machine learning model (S30); and
a second inspection stage of discriminating a type of abnormality found in the first inspection stage using a second machine learning model (S50).

2. The method of claim 1, further comprising a stage of performing data preprocessing on the hyperspectral image received in stage S10 (S20).

3. The method of claim 2, wherein the preprocessing stage (S20) comprises a stage of compressing data by performing principal component analysis (PCA) on the hyperspectral image.

4. The method of claim 1, wherein the first inspection stage (S30) comprises:
a stage of inputting a hyperspectral spectrum of a preset first detection area unit as input data into the first machine learning model (S310); and
a stage of comparing an output of the first machine learning model with the input data to determine whether each detection area is abnormal (S320).

5. The method of claim 4, wherein the second inspection stage (S50) comprises:
a stage of deciding a representative hyperspectral spectrum representing a second detection area covering a first detection area determined to be abnormal in the first inspection stage (S510);
a stage of generating a spectral similarity value between the representative hyperspectral spectrum and a normal spectrum (S520); and
a stage of inputting the spectral similarity value into the second machine learning model to determine the type of abnormality in the second detection area (S530).

6. The method of claim 1, wherein the first machine learning model is an autoencoder, and
wherein the second machine learning model is a convolutional neural network (CNN) model.

7. A computer-readable recording medium having recorded thereon a computer program for executing the product inspection method according to claim 1.
